(19) United States
(12) Patent Application Publication
(10) Pub. No.: US 2026/0285261 A1
(43) Pub. Date: Sep. 24, 2026

(54) HITCH MOUNT WITH JACK AND RECOVERY POINTS

(71) Applicant: Owl Vans, LLC, Mesa, AZ (US)

(72) Inventors: John Willenborg, Paradise Valley, AZ (US); Kevin Hale, Goodyear, AZ (US)

(21) Appl. No.: 19/086,250

(22) Filed: Mar. 21, 2025

(51) Int. Cl. B60S 11/00; B60D 1/02; B60D 1/58

(52) U.S. Cl. CPC B60S 11/00; B60D 1/02; B60D 1/58

(57) ABSTRACT

A vehicle recovery system and method have been developed. The system includes a hitch mount that is configured to extend from a vehicle. The hitch mount has a jack point. The jack point is configured to engage a jack that lifts the vehicle. The hitch mount further has a recovery point in the form of a recovery opening. The recovery point is configured to couple to a recovery accessory, such as a tow strap or cable, that is used to pull or tow the vehicle. The hitch mount has a nose. The nose extends from the hitch mount farther than the rest of the hitch mount. The nose is configured to keep the jack in engagement with the hitch mount during lifting.

### BACKGROUND

Vehicles often face the challenge of getting stuck or experiencing mechanical issues. This is especially true for off-road vehicles, large sport utility vehicles (SUVs), and trucks that frequently find themselves in challenging conditions. For example, off-road vehicles might get stuck in deep mud. Another common issue is a flat tire that has to be replaced. These challenges can be cumbersome and difficult.

Thus, there is a need for improvement in this field.

### SUMMARY

Flat tires can occur quite often when driving off road, and replacing the flat tire with a spare can be very challenging in such environments. Even finding level ground for positioning the jack and vehicle can be difficult. Typical jack points often require individuals to maneuver beneath a vehicle in order to properly align the jack with the designated jack points on the vehicle. This can be dangerous. If not properly positioned, the vehicle may for example fall off the jack which in turn can damage the vehicle or lead to serious injury.

Most modern passenger cars have a unibody construction where the body and frame of the car are integrated into a single structure. If the jack is not properly placed at the designated jack locations on the unibody, significant damage may occur. Most trucks, SUVs, and other off-road type vehicles have a body-on-frame construction where the body of the vehicle is mounted onto a separate frame. Sometimes the jack may be improperly positioned against the body or frame which can lead to significant damage to the vehicle. In either vehicle design, the resulting damage caused by the improperly placed jack can be very expensive to repair.

Similar issues may occur during vehicle recovery. For example, during off-roading, the vehicle may become stuck in mud, snow, sand, and the like. Commonly, tow straps, cables, and the like are secured to the stuck vehicle, a and winch that is coupled to the tow straps is used to pull out the vehicle. A common mistake is to not secure the tow straps to the proper designated recovery points on the vehicle. For instance, if the tow straps are secured to a weak point of the vehicle, like a bumper or suspension component, these components may break when tension is applied. Finding a proper recovery point can be difficult. Often times, an individual has to reach underneath the vehicle to find the recovery point. This can be increasingly difficult in challenging terrain such as terrain with rocks, mud, and/or snow.

The jack generally tends to apply a compressive force to the vehicle, and in contrast, the winch via the tow straps typically applies a tensile or pulling force to the vehicle. Given the type of forces applied are quite different, the location of the jack points for the jack may be different from the recovery points for the tow straps. This difference between the points may lead to confusion which in turn may cause improper placement of the jack or tow straps.

A unique recovery system for a vehicle has been developed to address the above-mentioned as well as other issues. The system provides a single, readily identifiable point where the jack and a recovery aid (e.g., a tow strap or cable) can be easily secured to the vehicle. During the development of the system, it was found that the hitch, and more particularly the hitch receiver, was sturdy enough to handle the compressive loads of the jack and the tensile forces of the tow straps or other recovery accessories. Hitch receivers typically provide a secure attachment point on a vehicle for towing trailers as well as other items and mounting various accessories like bike racks and cargo carriers. When towing or carrying mounted accessories, the hitch receiver will experience significant loads and torques, so the connection to the vehicle tends to be quite strong. In vehicles with unibody construction, the towing hitch receiver is typically mounted to a rear subframe or directly to the body of the vehicle to promote load stability and strength. For vehicles with body-on-frame construction, the tow hitch receiver is usually mounted directly to the frame rails at the rear of the vehicle. Depending on the vehicle, standard hitch receivers are typically bolted and/or welded directly to the chassis, body, and/or frame of the vehicle. Connected in this way, the hitch receiver can handle significant loads. This sturdy integration enables the hitch receiver to effectively transfer forces involved in pulling or lifting operations. The vehicle can be safely pulled, pushed, lifted, lowered, and/or otherwise moved using the hitch receiver. The use of the hitch receiver for lifting or pulling minimizes the risk of damage to the body or other components of the vehicle. The hitch receiver is typically visible to the user without having to look under the vehicle. As a result, the hitch receiver provides a convenient location for attachment.

In one version, the system includes a hitch mount that is removably coupled to the hitch receiver. In one form, the hitch mount includes both a jack point and a recovery point, and in other forms, the hitch mount may just include the jack point or the recovery point. The hitch mount can be easily attached to and removed from the hitch receiver on an as needed basis. For instance, the hitch mount can be removed from the hitch receiver during normal use such as when the hitch is used to tow a trailer. If the vehicle for example experiences a flat and/or needs to be pulled from mud, the hitch mount can be quickly inserted into and secured to the hitch receiver so as to provide a sturdy location for the jack and the tow straps.

The hitch mount in one form is generally hook-shaped. In one particular variation, the mount has a hook-shaped end that extends from a shank that is designed to be received in the hitch receiver. The hook-shaped end defines a jack engagement notch that is sized to receive a saddle of the jack. The notch in the hook-shaped end inhibits the jack from sliding off of the mount as the jack raises the vehicle. The hook-shaped end also provides a sturdy recovery point for securing tow straps and the like.

The hitch mount is further designed to facilitate changes in the force and the stroke length required to lift the vehicle with the jack. The hitch mount in some cases is able to move in a telescoping fashion relative to the hitch receiver to change the lever arm length for the jack. When the hitch mount is secured to the hitch receiver at the rear of the vehicle or otherwise secured to the rear of the vehicle, the force of the jack causes the vehicle to pivot about a rotational axis defined at the front wheels of the vehicle. Conversely, when the hitch mount is secured to the hitch receiver at the front of the vehicle or otherwise secured to the front of the vehicle, the force of the jack causes the vehicle to pivot about a rotational axis defined at the rear wheels of the vehicle. By being able to be adjusted in a telescoping manner, the hitch mount is able to change the length of the lever arm used to raise the vehicle. Through this, the hitch mount is able to change the stroke length and force needed to be imparted by the jack in order to raise the vehicle.

The length of the hitch mount relative to the vehicle can be set in a number of manners. For example, the shank in one version defines one or more adjustment holes that are positioned to align with one or more corresponding hitch pin holes in the hitch receiver when the shank is secured to the hitch receiver. In one case, a pin, bolt, or other detachable fastener is inserted through the holes in the hitch receiver and the hitch mount to secure the shank of the hitch mount to the hitch receiver. The adjustment holes in the shank align with the hitch pin holes in the hitch receiver when the shank of the hitch mount is inserted into the hitch receiver. When the adapter holes of the hitch mount align with the hitch pin holes in the hitch receiver, the pin, bolt, or other detachable fastener is inserted into the aligned holes to secure the hitch mount to the hitch receiver. In some particular examples, the detachable fastener includes a clevis pin with a cotter pin. The clevis pin is inserted into the hitch pin holes of the receiver and the adapter hole in the hitch mount. The clevis pin secures the hitch mount to the hitch receiver, and the cotter pin is inserted into the clevis pin to secure the clevis pin in place. The cotter pin prevents the clevis pin from sliding out of the holes. In other variations, the hitch mount can be integrated into the vehicle. For instance, the hitch mount can be welded onto the vehicle.

The inclusion of the holes along the shank of the hitch mount allows the user to adjust the extension length of the adapter according to specific needs. In one example, the user selects the extension length of the hitch mount by aligning the desired hole in the hitch mount with the hitch pin hole in the receiver. This ability to adjust the length can be helpful for situations that require specific positioning. For instance, when the notch in the hitch mount is positioned close to the hitch receiver, the jack is able to raise the vehicle higher as compared to when the notch is located farther away from the hitch receiver of the vehicle. This can be helpful when a large clearance is required to replace a large tire or perform some other repair activity. In contrast, when the hitch mount is extended farther away from the vehicle, the jack is able to impart a greater lifting force to lift the vehicle. Moreover, the ability to choose different extension lengths of the hitch mount is helpful in various towing and recovery scenarios. For instance, depending on the relative location of where the vehicle is stuck, the relative geometry between the winch and the vehicle can be varied.

The recovery system allows for easy access from a more comfortable position. The hitch mount eliminates the need to crawl under the vehicle. Not having to reach or crawl under the vehicle reduces the risk of injury and makes the process much safer. The connection of the hitch mount to the hitch receiver in a visible location makes aligning the jack easier. Likewise, the towing straps, cables, and the like can be conveniently secured to the hitch mount. The location of the hitch mount reduces setup time and minimizes user strain. This ease of access is helpful in adverse weather conditions or uneven terrain that can make positioning the jack or tow straps challenging

The hitch mount enables a jack to seamlessly engage with the hitch mount. The hitch mount eliminates actions typically required to secure the jack to the lift point. Users can simply position a saddle of the jack under the hitch mount and begin lifting without having to fasten or secure the jack to the hitch mount. The hitch mount is designed to provide a sturdy and stable connection between the jack and the hitch mount. The notch at the hook-shaped end of the hitch mount helps to ensure the jack remains secure and slip-resistant. This design reduces setup time and minimizes the complexity typically associated with preparing a vehicle for lifting. When raising the vehicle, the jack is located at a position along the sides of the vehicle.

The hitch mount in further variations includes a tow ring to accommodate various tow accessories. In some examples, the tow accessory includes the tow strap and/or a shackle. The tow ring offers a convenient location for attachment of the tow accessory. The hitch receiver is normally located well above the ground. With the hitch receiver located at such a position, the hitch mount is easy to access even in challenging terrain. The heightened visibility and accessibility of the tow ring reduces the need to maneuver under the vehicle. This enhanced accessibility also reduces the risk of injury that can result from difficult to reach positions.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a vehicle.

Aspect 3 generally concerns the system of any previous aspect in which the vehicle has a front side.

Aspect 4 generally concerns the system of any previous aspect in which the vehicle has a rear side.

Aspect 5 generally concerns the system of any previous aspect in which the vehicle has a bumper guard.

Aspect 6 generally concerns the system of any previous aspect in which the bumper guard is positioned on the front side of the vehicle.

Aspect 7 generally concerns the system of any previous aspect including a front bumper guard.

Aspect 8 generally concerns the system of any previous aspect in which the vehicle is an off-road vehicle.

Aspect 9 generally concerns the system of any previous aspect in which the vehicle is a truck.

Aspect 10 generally concerns the system of any previous aspect in which the vehicle is a van.

Aspect 11 generally concerns the system of any previous aspect including a chassis.

Aspect 12 generally concerns the system of any previous aspect in which the vehicle has the chassis.

Aspect 13 generally concerns the system of any previous aspect in which the vehicle is a body-on-frame type vehicle.

Aspect 14 generally concerns the system of any previous aspect in which the chassis has a body-on-frame construction.

Aspect 15 generally concerns the system of any previous aspect in which the chassis includes a frame.

Aspect 16 generally concerns the system of any previous aspect in which the vehicle is a unibody type vehicle.

Aspect 17 generally concerns the system of any previous aspect in which the chassis has a unibody construction.

Aspect 18 generally concerns the system of any previous aspect including a hitch.

Aspect 19 generally concerns the system of any previous aspect including a hitch receiver.

Aspect 20 generally concerns the system of any previous aspect in which the hitch includes the hitch receiver.

Aspect 21 generally concerns the system of any previous aspect in which the hitch receiver is secured to the vehicle.

Aspect 22 generally concerns the system of any previous aspect in which the hitch receiver is secured to the front side of the vehicle.

Aspect 23 generally concerns the system of any previous aspect in which the hitch receiver is secured to the rear side of the vehicle.

Aspect 24 generally concerns the system of any previous aspect in which the hitch receiver is secured to the chassis.

Aspect 25 generally concerns the system of any previous aspect in which the hitch receiver is secured to the frame.

Aspect 26 generally concerns the system of any previous aspect in which the hitch receiver is integrated into the bumper guard.

Aspect 27 generally concerns the system of any previous aspect in which the hitch receiver is a class 3 or higher hitch receiver type.

Aspect 28 generally concerns the system of any previous aspect in which the hitch receiver is a class 3, class 4, or class 5 hitch receiver.

Aspect 29 generally concerns the system of any previous aspect in which the hitch receiver is rated to have a maximum tongue weight to lift the vehicle.

Aspect 30 generally concerns the system of any previous aspect in which the hitch receiver is rated to support a tongue weight of at least 600 pounds.

Aspect 31 generally concerns the system of any previous aspect in which the hitch receiver is rated to support a tongue weight of at least 1,000 pounds.

Aspect 32 generally concerns the system of any previous aspect in which the hitch receiver is rated to support a tongue weight of at least 1,200 pounds.

Aspect 33 generally concerns the system of any previous aspect in which the hitch receiver has a towing capacity of at least 8,000 pounds.

Aspect 34 generally concerns the system of any previous aspect in which the hitch receiver has a towing capacity of at least 10,000 pounds.

Aspect 35 generally concerns the system of any previous aspect in which the hitch receiver includes a receiver tube.

Aspect 36 generally concerns the system of any previous aspect in which the receiver tube defines an opening.

Aspect 37 generally concerns the system of any previous aspect in which the receiver tube has a rectangular cross-sectional shape.

Aspect 38 generally concerns the system of any previous aspect in which the receiver tube has a square cross-sectional shape.

Aspect 39 generally concerns the system of any previous aspect in which the receiver tube has a receiver size of at least 2 inches.

Aspect 40 generally concerns the system of any previous aspect in which the opening in the receiver tube has a width of at least 2 inches.

Aspect 41 generally concerns the system of any previous aspect in which the opening in the receiver tube has a height of at least 2 inches.

Aspect 42 generally concerns the system of any previous aspect in which the receiver tube defines one or more hitch pin holes.

Aspect 43 generally concerns the system of any previous aspect in which the hitch pin holes are disposed on opposing sides of the receiver tube.

Aspect 44 generally concerns the system of any previous aspect including a jack.

Aspect 45 generally concerns the system of any previous aspect in which the jack is configured to lift the vehicle.

Aspect 46 generally concerns the system of any previous aspect in which the jack has a saddle.

Aspect 47 generally concerns the system of any previous aspect in which the jack has a ram that is extendable.

Aspect 48 generally concerns the system of any previous aspect in which the saddle is secured to the ram.

Aspect 49 generally concerns the system of any previous aspect including a recovery accessory.

Aspect 50 generally concerns the system of any previous aspect in which the recovery accessory includes a tow strap.

Aspect 51 generally concerns the system of any previous aspect in which the recovery accessory includes a tow cable.

Aspect 52 generally concerns the system of any previous aspect in which the recovery accessory includes a shackle.

Aspect 53 generally concerns the system of any previous aspect including a hitch mount.

Aspect 54 generally concerns the system of any previous aspect in which the hitch mount is configured to detachably couple to a hitch receiver.

Aspect 55 generally concerns the system of any previous aspect in which the hitch mount extends into the opening in the receiver tube.

Aspect 56 generally concerns the system of any previous aspect in which the hitch mount has a receiver portion configured to secure in the hitch receiver.

Aspect 57 generally concerns the system of any previous aspect in which the hitch mount has an engagement portion extending from the hitch receiver.

Aspect 58 generally concerns the system of any previous aspect in which the hitch mount has a receiver end and an engagement end extending opposite the receiver end.

Aspect 59 generally concerns the system of any previous aspect in which the receiver end is received in the receiver tube.

Aspect 60 generally concerns the system of any previous aspect in which the engagement end extends from the hitch receiver.

Aspect 61 generally concerns the system of any previous aspect in which the engagement portion includes a shaft.

Aspect 62 generally concerns the system of any previous aspect in which the shaft is received in the receiver tube.

Aspect 63 generally concerns the system of any previous aspect in which the hitch mount defines one or more adjustment holes.

Aspect 64 generally concerns the system of any previous aspect in which the shaft has at least two adjustment holes.

Aspect 65 generally concerns the system of any previous aspect in which the shaft has at least three or more adjustment holes.

Aspect 66 generally concerns the system of any previous aspect in which the adjustment holes are configured to align with the hitch pin holes in the receiver tube.

Aspect 67 generally concerns the system of any previous aspect in which the fastener extends through the hitch pin holes and one of the adjustment holes to secure the hitch mount to the hitch receiver.

Aspect 68 generally concerns the system of any previous aspect in which the fastener is a detachable fastener.

Aspect 69 generally concerns the system of any previous aspect in which the adjustment holes are configured to facilitate adjustment of a length of the hitch mount extending from the hitch receiver.

Aspect 70 generally concerns the system of any previous aspect in which the hitch mount has a step between the receiver portion and the engagement portion.

Aspect 71 generally concerns the system of any previous aspect in which the receiver portion is thicker than the engagement portion.

Aspect 72 generally concerns the system of any previous aspect in which the engagement portion is thinner than the receiver portion.

Aspect 73 generally concerns the system of any previous aspect in which the shaft is straight.

Aspect 74 generally concerns the system of any previous aspect in which the engagement portion is hook shaped.

Aspect 75 generally concerns the system of any previous aspect in which the shaft has a rectangular cross-sectional shape.

Aspect 76 generally concerns the system of any previous aspect in which the hitch mount has a jack point.

Aspect 77 generally concerns the system of any previous aspect in which the hitch mount has a recovery point.

Aspect 78 generally concerns the system of any previous aspect in which the hitch mount has both a jack point and a recovery point.

Aspect 79 generally concerns the system of any previous aspect in which the jack point and the recovery point are located at different locations on the hitch mount.

Aspect 80 generally concerns the system of any previous aspect in which the jack point and the recovery point at located at the same location on the hitch mount.

Aspect 81 generally concerns the system of any previous aspect in which the jack point is configured to engage the jack.

Aspect 82 generally concerns the system of any previous aspect in which the jack point rests against the saddle when the jack engages the hitch mount.

Aspect 83 generally concerns the system of any previous aspect in which the hitch mount has a cradle.

Aspect 84 generally concerns the system of any previous aspect in which the cradle is the jack point.

Aspect 85 generally concerns the system of any previous aspect in which the cradle is configured to engage the saddle of the jack when the jack engages the hitch mount.

Aspect 86 generally concerns the system of any previous aspect in which the saddle presses against the cradle when the jack engages the hitch mount.

Aspect 87 generally concerns the system of any previous aspect in which the cradle has a jack surface configured to engage the jack.

Aspect 88 generally concerns the system of any previous aspect in which the hitch mount defines a notch configured to receive the jack.

Aspect 89 generally concerns the system of any previous aspect in which the notch forms the cradle.

Aspect 90 generally concerns the system of any previous aspect in which the cradle includes a nose sidewall and a receiver sidewall disposed on opposing sides of the jack surface.

Aspect 91 generally concerns the system of any previous aspect in which the hitch mount has a nose.

Aspect 92 generally concerns the system of any previous aspect in which the nose is configured to keep the jack in engagement with the hitch mount during lifting.

Aspect 93 generally concerns the system of any previous aspect in which the nose is disposed at the engagement end.

Aspect 94 generally concerns the system of any previous aspect in which the nose extends from the hitch mount farther than the rest of the hitch mount.

Aspect 95 generally concerns the system of any previous aspect in which the nose extends a nose extension distance from the hitch mount.

Aspect 96 generally concerns the system of any previous aspect in which the nose is rounded.

Aspect 97 generally concerns the system of any previous aspect in which the nose has a hook.

Aspect 98 generally concerns the system of any previous aspect in which the hitch mount has a beveled surface and a bowed surface extending on opposing sides of the jack surface.

Aspect 99 generally concerns the system of any previous aspect in which the cradle has a groove defined between the bowed surface and the hook.

Aspect 100 generally concerns the system of any previous aspect in which the hook is configured to retain the jack in engagement with the hitch mount.

Aspect 101 generally concerns the system of any previous aspect in which the bowed surface is configured to prevent the jack from sliding off the hitch mount during lifting with the jack.

Aspect 102 generally concerns the system of any previous aspect in which the beveled surface is shaped to facilitate insertion of the jack into the cradle.

Aspect 103 generally concerns the system of any previous aspect in which the adjustment holes are configured to adjust a length of the hitch mount extending from the hitch receiver to adjust a stroke length of the jack needed to lift the vehicle.

Aspect 104 generally concerns the system of any previous aspect in which the adjustment holes are configured to adjust a length of the hitch mount extending from the hitch receiver to adjust a force the jack needs to apply to lift the vehicle.

Aspect 105 generally concerns the system of any previous aspect in which the hitch mount is slidably disposed in the hitch receiver.

Aspect 106 generally concerns the system of any previous aspect in which the cradle is the recovery point.

Aspect 107 generally concerns the system of any previous aspect in which the recovery point is configured to couple to the recovery accessory.

Aspect 108 generally concerns the system of any previous aspect in which the hitch mount defines a recovery opening.

Aspect 109 generally concerns the system of any previous aspect in which the recovery point is the recovery opening.

Aspect 110 generally concerns the system of any previous aspect in which the recovery opening has a circular cross-sectional shape.

Aspect 111 generally concerns the system of any previous aspect in which the recovery opening is larger than the adjustment opening.

Aspect 112 generally concerns the system of any previous aspect in which the recovery opening has a diameter that is larger than the diameters of the adjustment openings.

Aspect 113 generally concerns the system of any previous aspect in which the hitch mount is secured to the rear side of the vehicle.

Aspect 114 generally concerns the system of any previous aspect in which the hitch mount is secured to the front side of the vehicle.

Aspect 115 generally concerns the system of any previous aspect in which the hitch mount is permanently secured to the bumper guard.

Aspect 116 generally concerns the system of any previous aspect in which the hitch mount is integrated into the front bumper guard.

Aspect 117 generally concerns the system of any previous aspect in which the hitch mount has a catch that spans across the cradle to define a cradle opening.

Aspect 118 generally concerns the system of any previous aspect in which the hitch mount is configured to extend from a vehicle.

Aspect 119 generally concerns the system of any previous aspect in which the engagement portion defines the recovery opening.

Aspect 120 generally concerns the system of any previous aspect in which the engagement portion is thinner than the receiver portion to facilitate securing of a recovery accessory to the recovery opening.

Aspect 121 generally concerns a method.

Aspect 122 generally concerns the method of any previous aspect including inserting a hitch mount into a hitch receiver of a vehicle.

Aspect 123 generally concerns the method of any previous aspect including securing the hitch mount to the hitch receiver.

Aspect 124 generally concerns the method of any previous aspect including aligning a jack with a jack point on the hitch mount.

Aspect 125 generally concerns the method of any previous aspect including lifting the vehicle with the jack via the hitch mount.

Aspect 126 generally concerns the method of any previous aspect including lowering the vehicle with the jack.

Aspect 127 generally concerns the method of any previous aspect including coupling a recovery accessory to a recovery point on the hitch mount.

Aspect 128 generally concerns the method of any previous aspect including pulling the vehicle via the recovery accessory coupled to the recovery point of the hitch mount.

Aspect 129 generally concerns the method of any previous aspect in which the aligning the jack includes positioning the jack in a lateral location that is transverse to the hitch mount.

Aspect 130 generally concerns the method of any previous aspect in which the aligning the jack with the jack point includes inserting a saddle of the jack into the cradle.

Aspect 131 generally concerns the method of any previous aspect including retaining the jack on the hitch mount with a nose of the hitch mount during the lifting.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a hitch mount mounted on to a hitch receiver of a vehicle.

FIG. 2 is a side view of a jack engaging the FIG. 1 hitch mount.

FIG. 3 is a perspective view of the FIG. 1 hitch mount.

FIG. 4 is a side view of the FIG. 1 hitch mount.

FIG. 5 is an enlarged view of an engagement portion of the FIG. 1 hitch mount engaged by a saddle of the jack.

FIG. 6 is a top view of the FIG. 1 hitch mount.

FIG. 7 is a bottom view of the FIG. 1 hitch mount.

FIG. 8 is a side view of a strap secured to the FIG. 1 hitch mount.

FIG. 9 is a top view of a shackle secured to the FIG. 1 hitch mount.

FIG. 10 is a side view of another embodiment of a hitch mount.

FIG. 11 is an exploded view of another embodiment of a hitch.

FIG. 12 is a perspective view of another embodiment of a hitch mount.

FIG. 13 is a side view of the FIG. 12 hitch mount.

FIG. 14 is a perspective view of the FIG. 12 hitch mount integrated onto a front bumper guard of a vehicle.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

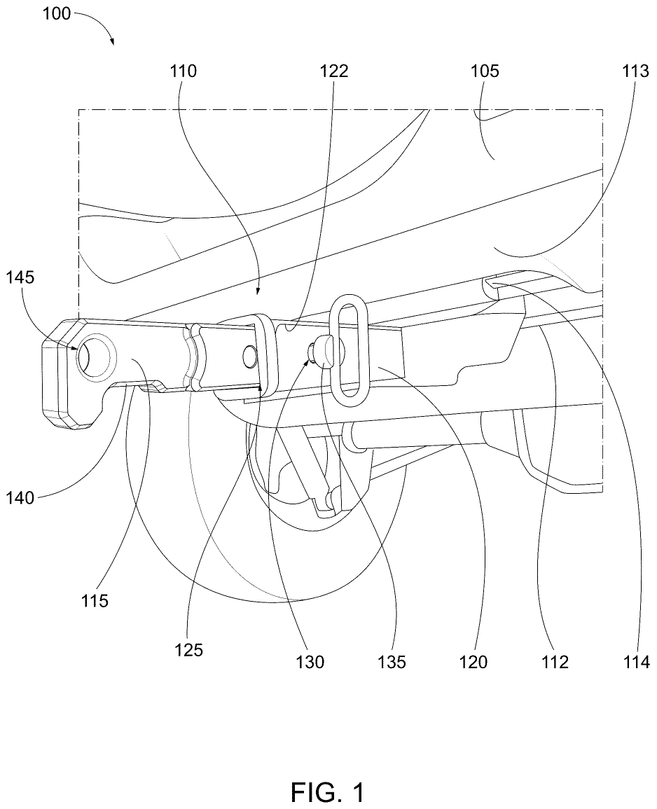

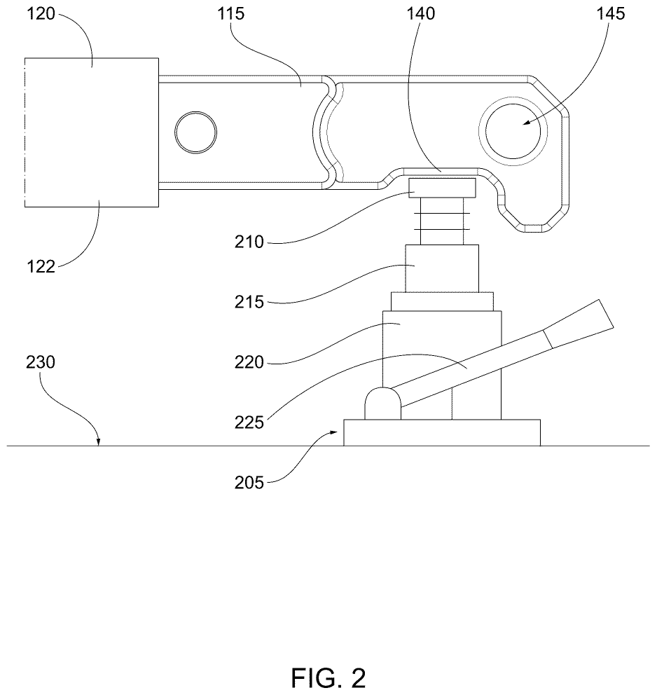

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 shows a vehicle system 100 according to one example. The system 100 includes a vehicle 105 with a hitch 110. The vehicle 105 has a chassis 112 to which the hitch 110 is secured. In some cases, the vehicle 105 is a van, an SUV, or a truck that uses a body-on-frame type construction, but the vehicle 105 can be constructed in other ways. For instance, the vehicle 105 in other cases has a unibody type construction. In the depicted example, the vehicle 105 has a body-on-frame type construction. In particular, the vehicle 105 has a body 113 mounted to a frame 114. The chassis 112 in the illustrated example includes the frame 114. The hitch 110 includes a hitch mount 115 that is received in a hitch receiver 120 of the vehicle 105. The hitch receiver 120 is secured to the chassis 112 of the vehicle 105, and more specifically, the hitch receiver 120 in the illustrated example is secured to the frame 114 of the vehicle 105. In some cases, the hitch mount 115 is made from aluminum or steel. In other variations, the hitch mount 115 is made from other metallic materials, non-metallic materials, or a combination of materials. The hitch receiver 120 has a receiver tube 122 that is secured to the chassis 112 of the vehicle 105. The receiver tube 122 defines an opening 125. The hitch mount 115 is received within the opening 125 of the receiver tube 122 of the hitch receiver 120. The hitch mount 115 in one form slidably engages the receiver tube 122 in a telescoping manner. This allows the relative extension length of the hitch mount 115 from the vehicle 105 to be adjusted

Trailer hitches are commonly categorized based on the location where the hitch is mounted on the vehicle as well as based on towing capacity. In the illustrated example, the hitch receiver 120 is a rear type hitch receiver. The hitch receiver 120 in other examples can be mounted elsewhere on the vehicle 105. For instance, the hitch receiver 120 in other examples is mounted to the front of the vehicle 105.

The Society of Automotive Engineers (SAE) has provided a general standard on how to classify trailer hitches based generally on towing capacity. Specifically, the international SAE J684 standard subdivides traditional hitch couplings into four classes (i.e., Classes 1 to 4), and the SAE J2638 standard generally provides a standard for couplings with even heavier loads. In practice, classifications of these two standards are combined into five (5) classes, where the lower number classes (e.g., Class 1 or 2) are for lighter towing loads and the higher classes (Classes 3, 4, and 5) are for heavier towing loads. It should be noted that Roman numerals are sometimes used instead to designate the classes

For Class 1 and 2 hitch receivers, the opening 125 in the receiver tube 122 has a generally rectangular, and in most cases square, cross-sectional shape. The size of the receiver tube 122 for Class 1 and Class 2 hitch receivers is about 1.25 inches square (3.175 cm). In other words, the opening 125 in the Class 1 or 2 receiver tube 122 has a length of about 1.25 inches (3.175 cm) and a width of about 1.25 inches (3.175 cm). The towing capacity of Class 1 and Class 2 hitch receivers respectively is about 2,000 pounds (907 kg) gross trailer weight (GTW) and about 3,500 pounds (1,588 kg) GTW. The torque weight limit typically represents the maximum acceptable vertical weight that is applied by a tongue of a trailer on a hitch. The maximum trailer tongue weights (TW)for Class 1 and Class 2 receivers are about 200 pounds (91 kg) and about 300 pounds (136 kg), respectively

In contrast to the Class 1 and 2 types, the receiver tube sizes for Class 3 and Class 4 hitch receivers are about 2 inches (5.08 cm). The opening 125 in the receiver tube 122 of the Class 3, Class 4, and Class 5 hitch receivers has a square cross-sectional shape such that each side has a length of about 2 inches (5.08 cm). Class 5 receivers commonly have a tube size of about 2.5 or 3 inches (6.35 cm or 7.62 cm). The Class 3, Class 4, and Class 5 hitch receivers have towing capacities of about up to 8,000 pounds (3,629 kg), up to about 10,000 pounds (4,536 kg), and over 10,000 pounds (4,536 kg), respectively. The maximum trailer tongue weights (TW)for Class 3, Class 4, and Class 5 hitch receivers are respectively about 600 pounds (272 kg), about 1,000 pounds (454 kg), and about 1,200 pounds (544 kg)

It was discovered in most cases the maximum tongue weights for the Class 1 and Class 2 hitch receivers were insufficient in most cases for the hitch mount 115 to raise the vehicle 105 via a jack. In other words, it was found that the hitch receiver 120 needs to be rated as at least a Class 3 or higher (e.g., Class 4 or Class 5) hitch receiver. The Class 3, Class 4, and Class 5 type hitch receivers 120 have sufficient tongue weight strength to allow the vehicle 105 to be lifted in a vertical direction via the hitch mount 115. The hitch mount 115 in this example has similar cross-sectional dimensions as the opening 125 in the receiver tube 122 so that the hitch mount 115 fits snuggly in the receiver tube 122. For example, the hitch mount 115 for a Class 2 or a Class 3 hitch receiver 120 has a width of about 2 inches (5.08 cm) and a thickness of about 2 inches (5.08 cm). In one example, the hitch receiver 120 is a rear type hitch receiver, and in one particular example, the hitch receiver 120 is a Class 3 type or higher (e.g., Class 4 or Class 5) type trailer hitch receiver. In some rare cases, however, the hitch receiver 120 can include other lower classes of hitch receivers. For example, the hitch receiver 120 in some cases, such as when the vehicle 105 is a light All-Terrain Vehicle (ATV), the hitch receiver 120 can include a Class 2 or even a Class 1 type hitch receiver

Once more, the receiver tube 122 of the hitch receiver 120 is mounted onto the chassis 112 of the vehicle 105. The direct connection of the hitch receiver 120 to the chassis 112 of the vehicle 105 ensures that the hitch receiver 120 can handle significant loads. The sturdy integration of the hitch receiver 120 with the vehicle 105 enables the hitch receiver 120 to effectively transfer forces involved in pulling or lifting motions of the hitch mount 115. The vehicle 105 can be safely pulled or lifted using the hitch receiver 120. In some versions, the hitch receiver 120 is integrated into the rear bumper of the vehicle 105. The hitch receiver 120 in some forms is located underneath the bumper of the vehicle 105. The location of the hitch receiver 120 at the rear of the vehicle 105 allows for easy access and attachment of towing accessories

The receiver tube 122 of the hitch receiver 120 defines one or more hitch pin holes 130. Typically, but not always, the hitch pin holes 130 are formed in opposing sides of the receiver tube 122, and a detachable fastener 135, such as a pin or bolt, is inserted through the hitch pin holes 130 in the hitch receiver 120 and through a hole the hitch mount 115 to secure the hitch mount 115 to the hitch receiver 120. Once secured, the detachable fastener 135 prevents the hitch mount 115 from sliding in and out of the hitch receiver 120. In one example, the fastener 135 includes a clevis pin with a cotter pin. The clevis pin prevents the hitch mount 115 from sliding in and out of the hitch receiver 120. The cotter pin fits into one end of the clevis pin. The cotter pin prevents the clevis pin from coming out of the hitch pin holes 130.

As will be explained below, the hitch mount 115 in the illustrated example has both a jack point 140 and a recovery point 145. In other versions, the hitch mount 115 just has the jack point 140 or the recovery point 145, but the hitch mount 115 does not have both the jack point 140 and the recovery point 145. The jack point 140 is structured so that a jack can be positioned to raise the vehicle 105. The recovery point 145 is designed so that a towing accessory, such as a tow cable or tow strap, can be used to tow the vehicle 105. In some cases, the jack point 140 can act as both a jack and a recovery point.

FIG. 2 shows a side view of a jack 205 engaging the jack point 140 of the hitch mount 115. In one version, the jack 205 is a hydraulic jack. However, it should be appreciated that other types of jacks can be used. A hydraulic jack typically operates by using fluid pressure to lift heavy loads. The jack 205 includes a saddle 210 that engages the hitch mount 115 for lifting the vehicle 105. A ram 215 is connected to the saddle 210. The ram 215 drives the saddle 210 in a lifting direction. The ram 215 is partially located inside a filler plug 220. The ram 215 is a piston-like component that extends to lift a load. A lever 225 is connected to the filler plug 220. Fluid is forced into the filler plug 220 as the lever 225 is pumped. The ram 215 extends out of the filler plug 220 as fluid pressure increases inside the filler plug 220

In this example, the jack 205 sits on top of a support surface, such as ground 230. The hitch mount 115 is coupled to the hitch receiver 120 of the vehicle 105. Typically, but not always, the jack 205 is positioned along one lateral side of the hitch mount 115. In other examples, the jack 205 is positioned directly underneath the hitch mount 115. The hitch mount 115 is pushed away from the ground 230 as the saddle 210 of the jack 205 extends way from the ground 230. The hitch mount 115 lifts the hitch receiver 120 and the vehicle 105. The vehicle 105 is lifted at an angle. One side of the vehicle 105 engages the ground 230. The other end of the vehicle 105 is lifted off of the ground 230.

The saddle 210 is aligned by the user under the jack point 140 of the hitch mount 115. The position of the hitch mount 115 on the hitch receiver 120 provides a convenient location to lift the vehicle. The hitch receiver 120 is located relatively low to the ground 230. The low location of the hitch receiver 120 enables jacks of smaller sizes to lift the vehicle. The user does not have to reach under the vehicle to place the saddle 210. The jack 205 engages the hitch mount 115 without any additional steps to secure the jack 205 to the hitch mount 115. The hitch mount 115 secures the saddle 210. The hitch mount 115 prevents the saddle 210 from slipping. The engagement of the jack 205 to the hitch mount 115 facilitates quick and easy lifting of the vehicle 105. The hitch mount 115 is useful for applications that require frequent lifting. For instance, drivers of off-road vehicles often require the installation of aftermarket accessories such as skid plates or lift-kits. The installation of such accessories can require frequent lifting of the vehicle 105 to access components under the vehicle 105. Lifting the vehicle 105 also allows the user to perform maintenance with ease. The user can have access to change tires, make repairs, or inspect under body components.

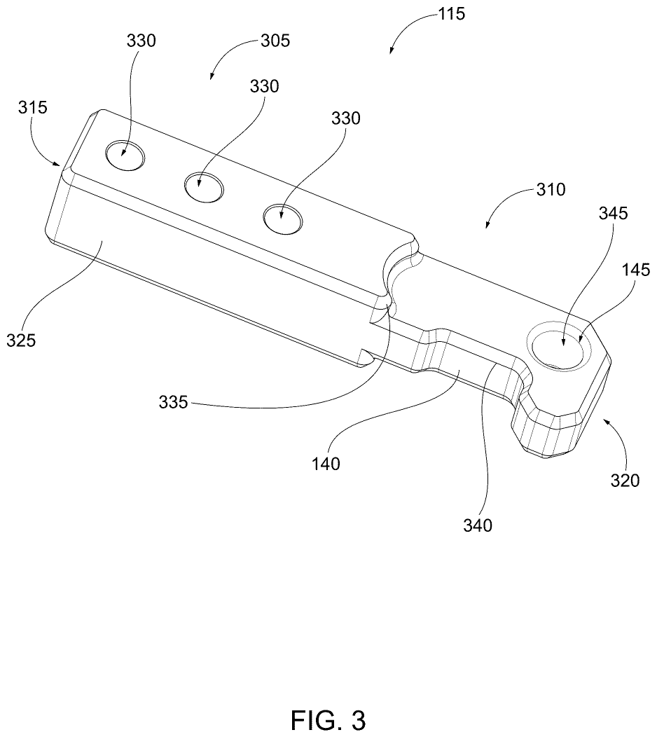

FIG. 3 shows a perspective view of the hitch mount 115. The hitch mount 115 includes a receiver portion 305 that is inserted into the hitch receiver 120 and an engagement portion 310 where the jack 205 engages the hitch mount 115. The receiver portion 305 is located at a receiver end 315 of the hitch mount 115, and the engagement portion 310 is located at an engagement end 320 of the hitch mount 115. The engagement end 320 extends opposite to the receiver end 315. The engagement end 320 is generally hook-shaped, and the shank 325 is generally straight. At least part of the shank 325 of the receiver portion 305 is received within the hitch receiver 120 of the vehicle 105. The receiver portion 305 has a shank 325 that extends into the receiver tube 122 of the hitch receiver 120 when the hitch mount 115 is secured to the hitch receiver 120. In one example, the shank 325 has a rectangular cross section. The shank 325 is sized to fit into the opening 125 in the receiver tube 122 of the hitch receiver 120. The shank 325 slidably engages the hitch receiver 120 of the vehicle 105. The shank 325 further defines one or more adjustment holes 330. The adjustment holes 330 are configured to secure the hitch mount 115 to the hitch receiver 120

In the illustrated example, the receiver portion 305 defines at least three adjustment holes 330 that extend through the opposing sides of the shank 325. In other examples, the receiver portion 305 can have more or less adjustment holes 330. The adjustment holes 330 are spaced apart along a longitudinal axis of the hitch mount 115. The spacing of the adjustment holes 330 along the longitudinal axis allows the user to selectively secure the hitch mount 115 to the hitch receiver 120. The adjustment holes 330 align with the hitch pin holes 130 on the hitch receiver 120. The fastener 135 slides through the hitch pin holes 130 and one of the adjustment holes 330 to lock the hitch mount 115 in place. The hitch mount 115 is unable to slide in and out of the hitch receiver 120 in a locked position. The user can select how far the hitch mount 115 extends from the hitch receiver 120 by selecting the desired adjustment hole 330 to align with the hitch pin holes 130. This selectivity is advantageous for situations that require specific positioning. For example, the jack 205 lifts the vehicle 105 to a higher position when the jack 205 is nearest to the vehicle 105. In one example, the hitch mount 115 is installed in a position that extends less from the hitch receiver 120. The smaller extension allows the jack 205 to lift the vehicle 105 higher. In other examples, the jack 205 can be located farther from the vehicle 105. For instance, the jack 205 is positioned farther from the vehicle 105 to prevent contact of the jack 205 with the vehicle 105

The engagement portion 310 extends from the receiver portion 305. Between the receiver portion 305 and the engagement portion 310, the hitch mount 115 has a step 335. As can be seen, the step 335 is located at the transition from the receiver portion 305 to the engagement portion 310. In the illustrated example, the jack point 140 at the engagement portion 310 includes a cradle 340, and the recovery point 145 includes a recovery opening 345 that is defined in the engagement portion 310. The cradle 340 of the engagement portion 310 is configured to engage the jack 205. The cradle 340 typically faces the ground 230 when installed onto the hitch receiver 120. The user can align the saddle 210 underneath the cradle 340. The saddle 210 of the jack 205 engages the cradle 340 to lift the vehicle 105. The recovery opening 345 is configured to secure to a tow accessory. In one example, the recovery opening 345 is a hole that passes through the engagement portion 310 of the hitch mount 115. The recovery opening 345 has beveled edges. The beveled edges guide tow accessories smoothly into place. The beveled edges minimize wear on the tow accessories.

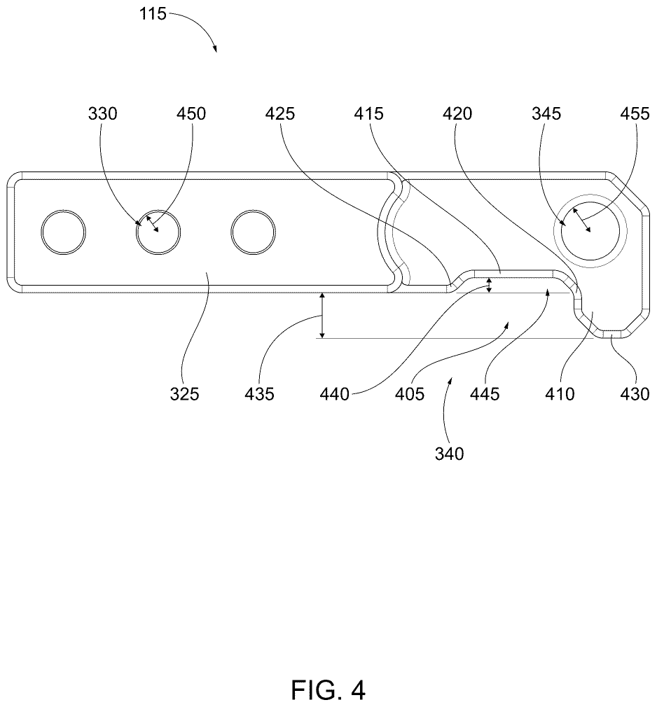

FIG. 4 shows a side view of the hitch mount 115. The recovery opening 345 has a notch 405 and a nose 410. The nose 410 is located at the engagement end 320. The nose 410 extends away from the notch 405. The notch 405 includes a jack surface 415 with a nose sidewall 420 and a receiver sidewall 425 located on opposing sides of the notch 405. The jack surface 415 is designed to receive the saddle 210 of the jack 205. The jack surface 415 receives most of the force exerted by the jack 205 during lifting. The nose 410 is configured to prevent the saddle 210 from slipping off from the hitch mount 115

The engagement end 320 of the hitch mount 115 is angled away from the ground 230 as the vehicle 105 is lifted. The nose sidewall 420 extends between the nose 410 and the jack surface 415. The nose sidewall 420 is a surface that faces the saddle 210 when the jack 205 is engaged with the hitch mount 115. The saddle 210 engages the nose sidewall 420 with increasing force as the angle of the engagement end 320 of the hitch mount 115 increases. The nose sidewall 420 prevents the saddle 210 from sliding off of the hitch mount 115 and away from the vehicle 105. The receiver sidewall 425 extends between the jack surface 415 and the receiver end 315 at an angle. The receiver sidewall 425 prevents the saddle 210 of the jack 205 from slipping towards the receiver end 315 when lifting. The receiver sidewall 425 assists in aligning the saddle 210 onto the jack surface 415. The saddle 210 is received between the nose sidewall 420 and the receiver sidewall 425

The nose 410 includes a tip 430. The tip 430 is a surface of the nose 410. A nose extension distance 435 defines the distance between the shank 325 and the tip 430. The nose extension distance 435 forms the nose 410. A notch depth 440 defines the distance from the jack surface 415 to the shank 325. The notch depth 440 forms a cavity 445. The cavity 445 receives the saddle 210. The nose 410 prevents movement of the saddle 210 away from the vehicle 105. In this example, the distance of the nose extension distance 435 is greater than the distance of the notch depth 440

The adjustment holes 330 have an adjustment hole diameter 450. Standard hitch receivers typically accommodate fasteners 135 that are about 16 mm in diameter. In one example, the adjustment hole diameter 450 accommodates fasteners 135 that are about 16 mm in diameter. In other examples, the adjustment hole diameter 450 accommodates fasteners 135 with diameters larger or smaller than 16 mm

The recovery opening 345 has a recovery opening diameter 455. In one example, the recovery opening diameter 455 is larger than the adjustment hole diameter 450. In other examples, the recovery opening diameter 455 is smaller or the same size as the adjustment hole diameter 450. In this example, the recovery opening 345 is a circular hole. In other examples, the recovery opening 345 is an oval or other shaped hole. The recovery opening 345 is located at the engagement end 320. The location of the recovery opening 345 allows for the user to have easy access to attach tow accessories. The hitch receiver 120 is typically in a raised position from the ground. The heightened visibility and accessibility of the recovery opening 345 reduces the need to maneuver under the vehicle 105

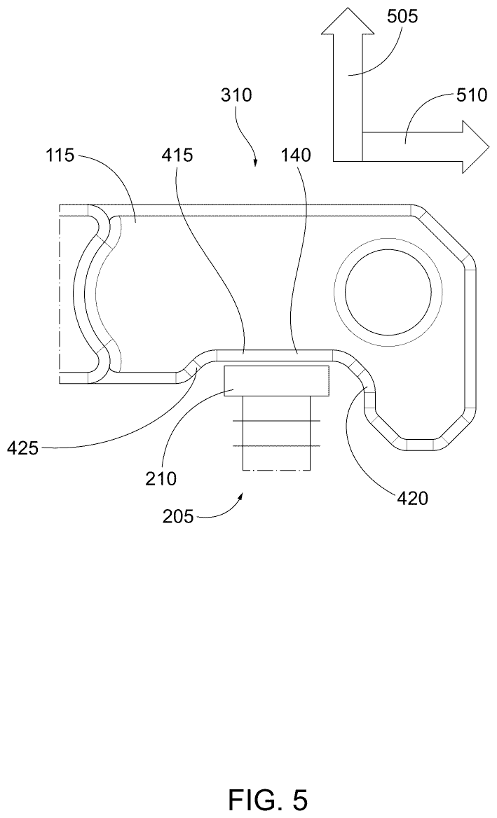

FIG. 5 shows an enlarged view of the engagement portion 310 with the jack point 140 in contact with the saddle 210. In one example, the saddle 210 covers the entire jack surface 415. In one example, the saddle 210 is in contact with the nose sidewall 420 and the receiver sidewall 425 simultaneously. In other examples, the saddle 210 contacts an area smaller than the full area of the jack surface 415. In some examples, the saddle 210 includes raised edges to prevent movement of the jack 205 in a direction perpendicular to the hitch mount 115.

In this example, the hitch mount 115 is in a non-lifted position. The jack 205 pushes the saddle 210 away from the ground 230. The saddle 210 pushes the hitch mount 115 into a lifted position away from the ground 230. The hitch mount 115 moves away from the ground 230 at an angle. The engagement end 320 is the furthest part of the hitch mount 115 from the ground 230 in a lifted position. The saddle 210 is received between the nose sidewall 420 and the receiver sidewall 425

When the jack 205 lifts the vehicle 105, the hitch mount 115 experiences both a vertical force vector 505 and a horizontal force vector 510. During initial contact of the saddle 210 with the notch 405, the hitch mount 115 mainly experiences the vertical force vector 505. As the jack 205 further raises the vehicle 105, the vehicle 105 tends to pivot or tilt which in turn increases the horizontal force vector 510. In one example, the saddle 210 engages the nose sidewall 420 in a lifted position. The nose sidewall 420 prevents the saddle 210 from sliding off the engagement end 320 of the hitch mount 115. More force is applied to the nose sidewall 420 as the angle of the hitch mount 115 increases. The receiver sidewall 425 prevents the saddle 210 from sliding toward the vehicle 105. In one example, the receiver sidewall 425 assists in aligning the saddle 210 to the jack surface 415. The angle of the nose sidewall 420 guides the saddle 210 towards the jack surface 415

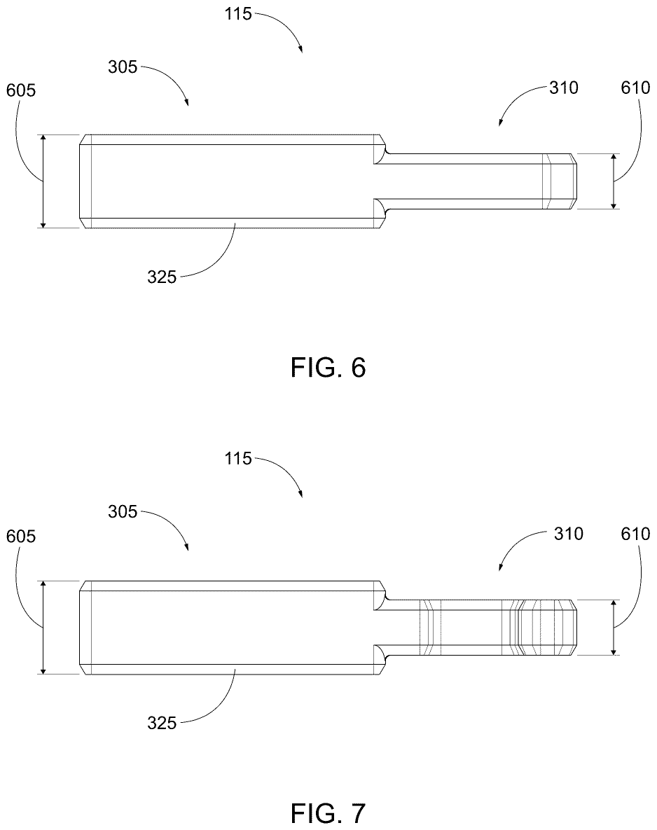

FIGS. 6 and 7 show a top and bottom view of the hitch mount 115. The shank 325 of the receiver portion 305 is wider than the engagement portion 310. The shank 325 is sized to fit in the hitch receiver 120 of the vehicle 105. The shank 325 has a shaft width 605, and the engagement portion 310 has an engagement width 610. The engagement width 610 is sized to accommodate certain tow accessories like tow straps, cables, or ropes. In one example, the tow accessory includes a shackle. The shackle has a jaw opening that fits the engagement width 610. In one example the engagement width 610 is sized to fit a standard jaw opening of about 32 mm. In other examples, the engagement width 610 is sized to fit larger or smaller jaw openings than 32 mm

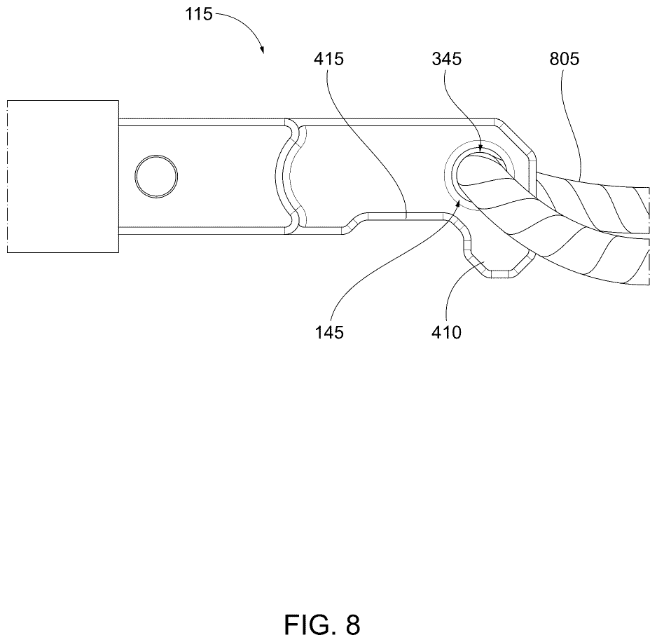

FIG. 8 shows an example of a strap 805 coupled to the hitch mount 115. In this example, the strap 805 is inserted into the recovery opening 345 of the recovery point 145. The strap 805 facilitates pulling of the vehicle via the hitch mount 115. In one example, the strap 805 is attached to a recovery vehicle. The recovery vehicle pulls the vehicle 105 using the strap 805. The strap 805 is typically made of durable materials like nylon or polyester. The strap 805 is designed to withstand significant tensions and absorb shocks during the pulling process. The strap 805 is typically used in off-road recovery or when a vehicle is immobilized on challenging terrain. In another variation, the strap 805 is hooked by the nose 410 and wrapped around the jack surface 415.

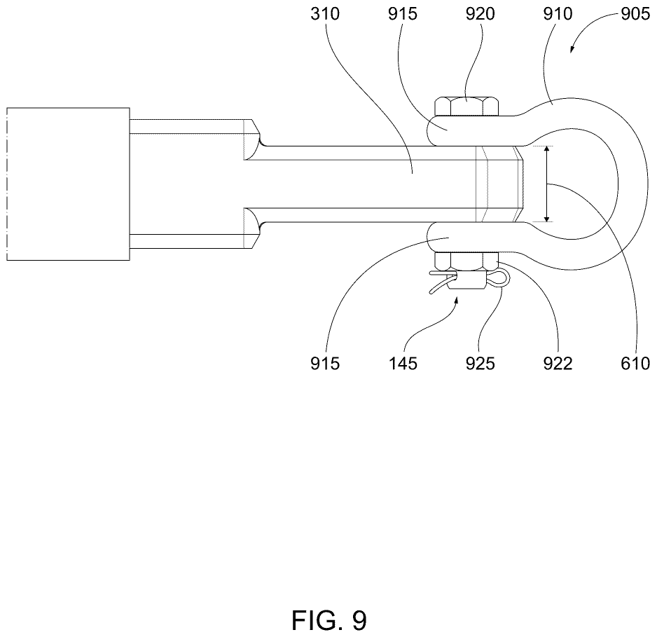

FIG. 9 shows an example of a shackle 905 coupled to the recovery point 145 of the hitch mount 115. The shackle 905 includes a crown 910. The crown 910 includes ears 915 that wrap around the engagement portion 310 of the hitch mount 115. The engagement width 610 is sized so that the engagement portion 310 fits between the ears 915. In this example, the shackle 905 includes a bolt 920 with a nut 922. Together, the bolt 920 and the nut 922 couple the shackle 905 to the hitch mount 115. The bolt 920 extends through the ears 915 and the recovery opening 345 of the hitch mount 115. The shackle 905 further has a clip 925 that secures the nut 922 in place. The clip 925 prevents the nut 922 from backing out off the bolt 920. The shackle 905 is used to pull a vehicle by acting as a connector between the hitch mount 115 and a recovery vehicle. The shackle 905 is designed to withstand substantial loads and provide a secure link in the recovery setup

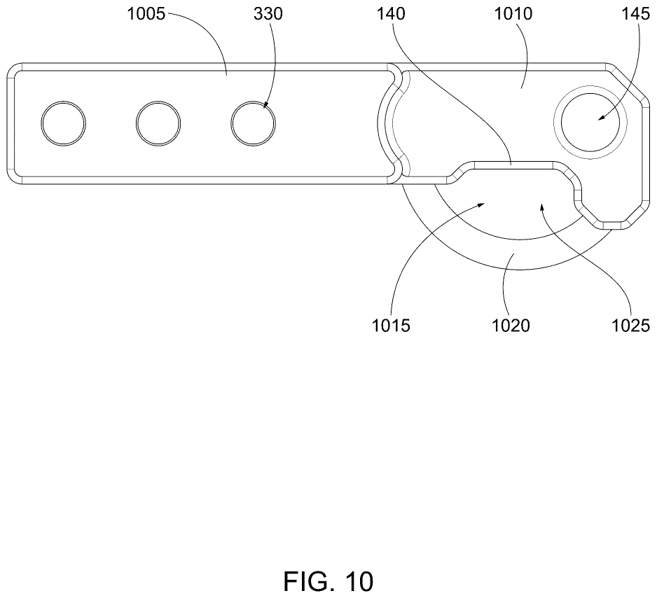

FIG. 10 illustrates a hitch mount 1005 according to another example that includes both the jack point 140 and the recovery point 145. In this embodiment, the hitch mount 1005 has an engagement portion 1010. The engagement portion 1010 of the hitch mount 1005 has a cradle 1015 and a catch 1020. The cradle 1015, which acts as the jack point 140, is configured to secure the saddle 210 of the jack 205. The catch 1020 is configured to further secure the saddle 210. The catch 1020 forms a saddle opening 1025. The saddle opening 1025 is configured to retain the saddle 210 of the jack 205. In one example, the saddle 210 is inserted into the saddle opening 1025. The catch 1020 provides frictional force on the saddle 210 to prevent the saddle 210 from slipping. In one example, the catch 1020 prevents the saddle 210 from moving when the saddle 210 is inserted in the saddle opening 1025

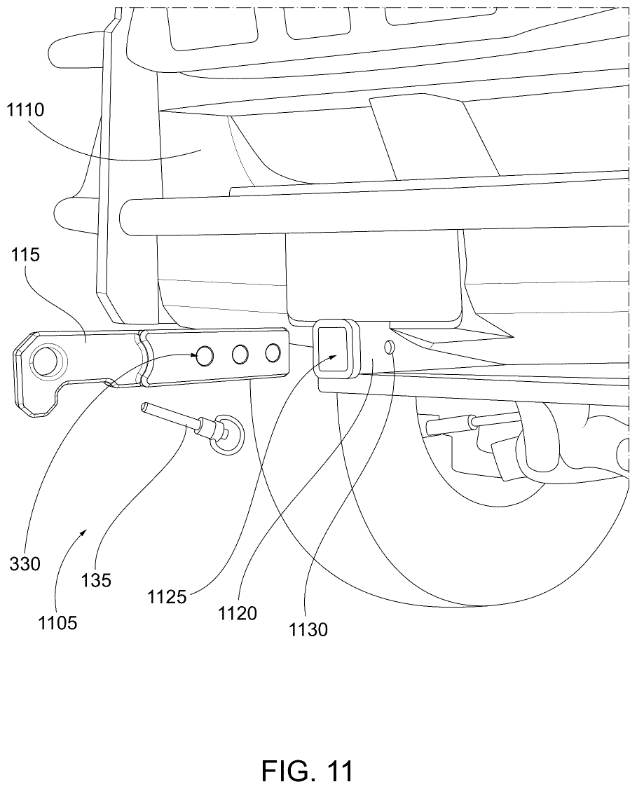

FIG. 11 illustrates an exploded view of another embodiment of a hitch 1105. In this embodiment the hitch 1105 is located on the front side of a vehicle 1110. The hitch 1105 includes the hitch mount 115 of the type initially described with reference to FIG. 1 and a hitch receiver 1120. When installed, the hitch mount 115 is received in the hitch receiver 1120. The hitch receiver 1120 defines an opening 1125. The hitch mount 115 is configured to fit into the opening 1125. The hitch mount 115 slidably engages the opening 1125. In one example, the hitch receiver 1120 is a Class 3 hitch receiver. In some versions, the hitch receiver 1120 is integrated into the front bumper of the vehicle 1110. In other versions, the hitch receiver 1120 is located underneath the front bumper of the vehicle 1110. The location of the hitch receiver 1120 at the front of the vehicle 1110 allows for easy access and attachment of towing accessories

The hitch receiver 1120 further has one or more hitch pin holes 1130. Like before, the fastener 135 is configured to secure the hitch mount 115 to the hitch receiver 1120. The fastener 135 fits into the hitch pin holes 1130 and engages the hitch mount 115 in the same manner as described above. The fastener 135 again prevents the hitch mount 115 from sliding in and out of the hitch receiver 1120. In one example, the fastener 135 includes a clevis pin with a cotter pin. The clevis pin prevents the hitch mount 115 from sliding in and out of the hitch receiver 1120. The cotter pin fits into one end of the clevis pin. The cotter pin prevents the clevis pin from coming out of the hitch pin holes 1130

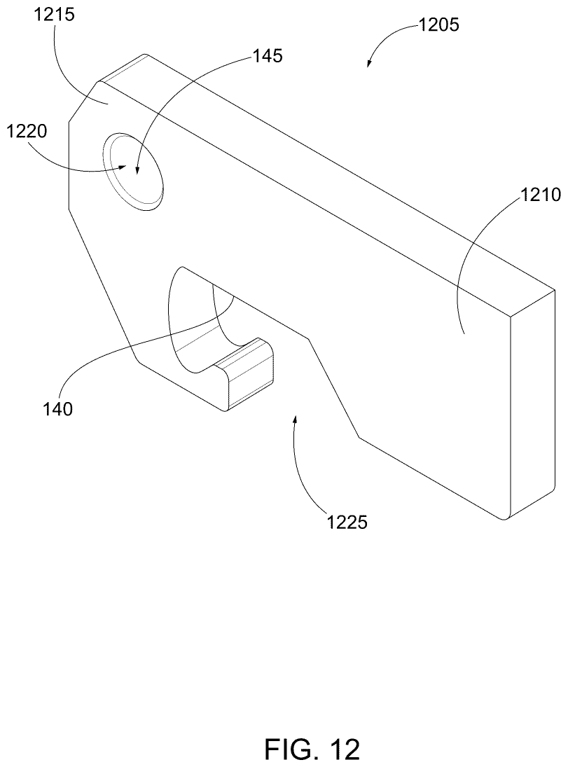

FIG. 12 illustrates a hitch mount 1205 with the jack point 140 and the recovery point 145 according to another embodiment. In this illustrated example, the] hitch mount 1205 has a shank 1210 and an engagement portion 1215. The shank 1210 and the engagement portion 1215 extend in opposite directions. In this version, the hitch mount 1205 has a uniform width across the length of the hitch mount 1205. As a result, the shank 1210 and the engagement portion 1215 have the same width. In one example the shank 1210 is integrated onto the vehicle. For instance, the hitch receiver 120 is welded onto the front of the vehicle. In other examples, the shank 1210 is detachably coupled to the vehicle

The engagement portion 1215 extends away from the vehicle. The engagement portion 1215 has a recovery opening 1220 that functions as the recovery point 145 and a cradle 1225 that functions as the jack point 140. The recovery opening 1220 is configured to secure a tow accessory. In one example, the recovery opening 1220 is a hole that passes through the engagement portion 1215 of the hitch mount 1205. In one example, the recovery opening 1220 is a circular hole. In other examples, the recovery opening 1220 can be an oval or other shaped hole. The recovery opening 1220 has beveled edges. The beveled edges guide tow accessories smoothly into place. The beveled edges minimize wear on the tow accessories. The cradle 1225 of the engagement portion 1215 is configured to engage the jack. The user can align the saddle of the jack underneath the cradle 1225. The saddle of the jack engages the cradle 1225 to lift the vehicle.

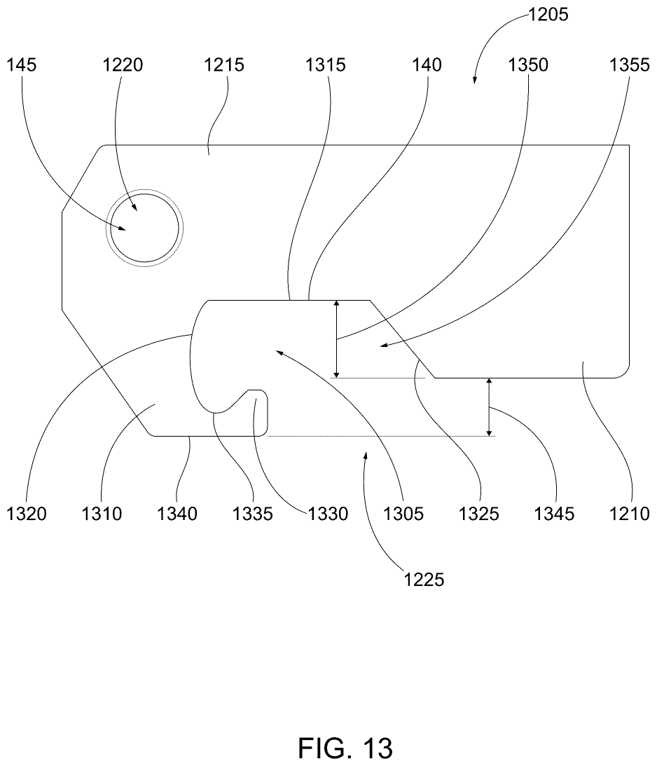

FIG. 13 shows a side view of the hitch mount 1205. The cradle 1225 includes a notch 1305 and a nose 1310. The notch 1305 includes a jack surface 1315, a bowed surface 1320, and a beveled surface 1325. The jack surface 1315 is designed to receive the saddle of the jack. The jack surface 1315 receives most of the force exerted by the saddle during lifting. The nose 1310 is configured to prevent the saddle from slipping away from the vehicle

The engagement portion 1215 is angled away from the ground 230 as the vehicle is lifted. The bowed surface 1320 extends between the nose 1310 and the jack surface 1315. The bowed surface 1320 is a surface that faces the saddle when the jack is engaged with the hitch mount 1205. The saddle engages the bowed surface 1320 with increasing force as the angle of the engagement portion 1215 increases away from the ground 230. The bowed surface 1320 prevents the saddle from sliding away from the vehicle. The beveled surface 1325 extends between the jack surface 1315 and the shank 1210 at an angle. The beveled surface 1325 prevents the saddle from slipping towards the shank 1210 when lifting. The beveled surface 1325 assists in aligning the saddle onto the jack surface 1315. The saddle is received between the bowed surface 1320 and the beveled surface 1325

The nose 1310 includes a hook 1330. The hook 1330 extends towards the jack surface 1315. The hook 1330 forms a groove 1335. The groove 1335 is shaped to catch a part of the saddle. The groove 1335 secures the saddle into place. The groove 1335 prevents the saddle from slipping

The nose 1310 includes a tip 1340. The tip 1340 is a surface of the nose 1310. A nose extension distance 1345 defines the distance between the shank 1210 and the tip 1340. The nose extension distance 1345 forms the nose 1310. A notch depth 1350 defines the distance from the jack surface 1315 to the shank 1210. The notch depth 1350 forms a cavity 1355. The cavity 1355 receives the saddle. In this version, the distance of the notch depth 1350 is greater than the distance of the nose extension distance 1345

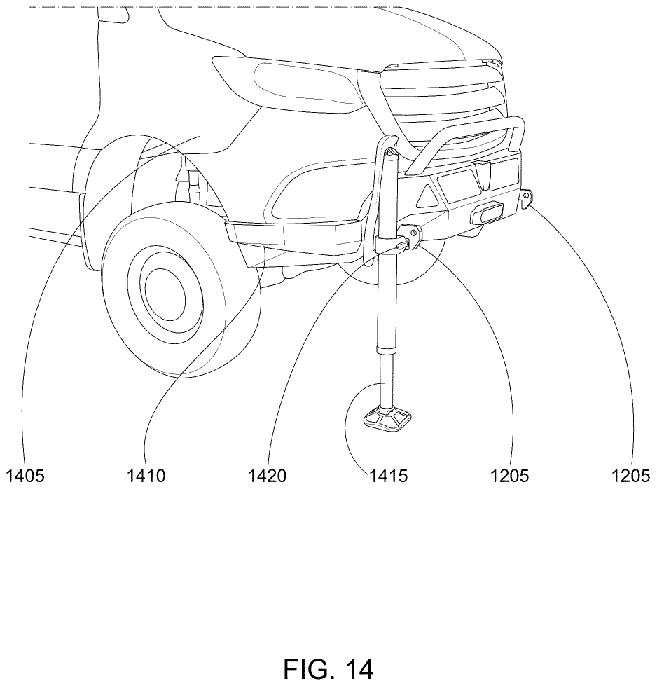

FIG. 14 illustrates the hitch mount 1205 integrated on a vehicle 1405. The vehicle 1405 includes a front bumper guard 1410. The front bumper guard 1410 is secured to the chassis of the vehicle 1405. In this example, two hitch mounts 1205 extend from the front bumper guard 1410. A jack 1415 is engaged with one of the hitch mounts 1205. The jack 1415 includes a saddle 1420. The saddle 1420 is received within the notch 1305 of the hitch mount 1205. In this example, the vehicle 1405 is in a lifted position

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example, if the stated value is 4.375, then use of the term “about 4.375” generally means a range between 3.9375 and 4.8125.

“Aftermarket Product” generally refers to one or more parts and/or accessories used in repair and/or enhancement of a product already made and sold by an Original Equipment Manufacturer (OEM). For example, aftermarket products can include spare parts, accessories, and/or components for motor vehicles

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Bolt” generally refers to a type of fastener designed to hold objects together that commonly includes a shaft with threads and a head at one end. In most cases, the head usually has a hexagonal shape, but the head can be shaped different. The bolt is typically made of metal, but the bolt can be made from other materials like plastic. Bolts are typically used with nuts to secure materials. For example, the bolt is passed through a hole in the materials, and the nut is tightened to the threaded shaft on the opposite side opposite to the head to create a strong and stable connection. Bolts are commonly used in construction, machinery, and automotive applications.

“Cavity” generally refers to an empty space in a solid object. The cavity can be completely or partially surrounded by the solid object. For example, the cavity can be opened to the surrounding environment

“Chassis” generally refers to a load-bearing structural framework of a vehicle that directly or indirectly supports all other components of the vehicle, including (but not limited to) the motor, transmission, suspension, and body. In body-on-frame vehicles, the chassis is a separate, rigid frame providing primary structural support for a separate body of the vehicle as well as the other components of the vehicle. In other words, the chassis in a body-on-frame vehicle is a distinct, rigid frame upon which the body of the vehicle is mounted so as to provide the primary structural support. Body-on-frame vehicles are commonly used in heavy-duty type applications. In unibody vehicles, the functions of the frame and the body are integrated into a single chassis structure that provides enhanced rigidity and fuel efficiency. To say it another way, the chassis and body are integrated into a single, cohesive structure in a unibody type vehicle, where the body panels themselves contribute significantly to the overall strength and rigidity of the vehicle. In both types of vehicle designs, the chassis serves as the main attachment point for components like receiver hitches.

“Cradle” generally refers to a structure or component designed to support or securely hold another object. The shape of a cradle often includes curved or contoured surfaces that conform to the object being supported, allowing it to nestle or rest securely within the cradle.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Frame” generally refers to a rigid structural foundation of a body-on-frame vehicle. In the body-on-frame vehicle, the frame and body are separate components that are assembled together. The frame provides the primary support for the motor, transmission, suspension, and/or body. Unlike a unibody construction where the chassis and body are integrated, the frame in a body-on-frame vehicle is a separate entity to which all major components are attached. The frame normally is designed to handle heavy loads and stresses which make the body-on-frame design suitable for trucks and off-road vehicles.

“Hitch Receiver” refers to a component of a specific type of tow hitch that is characterized by a receiver tube that is mounted to a chassis of a vehicle. The hitch receiver is designed to accept removable hitch-mounted accessories. This receiver tube defines an opening into which these hitch-mounted components, like ball mounts, bike racks, or cargo carriers, can be inserted. The hitch-mounted components can be secured to the hitch receiver via a detachable fastener, such as a hitch pin or bolt. Unlike fixed drawbar hitches, which are unitary structures, the hitch receiver provides versatility by allowing for the quick interchange of accessories. This quick interchange makes the hitch receiver adaptable to various towing and carrying needs. Hitch receivers are commonly classified into different classes (I to V) based on the towing capacity of the hitch receiver. These classes are typically identified with Arabic or Roman numerals. Common types of hitch receivers can include Class I, Class II, Class III, Class IV, and Class V, each designed to handle different weight capacities and applications. By way of non-limiting examples, Class I and II hitch receivers are suitable for light-duty towing, such as small trailers and bike racks, while Class III and IV can handle medium to heavy loads like boats and campers. Class V receivers are used for heavy-duty applications, including large trailers and equipment. Hitch receivers typically come in sizes of 32 mm, 51 mm, 64 mm, and 76 mm to accommodate various towing and carrying needs.

“Hoist” generally refers to the action of moving an object. By way of non-limiting examples, moving can encompass lifting, pulling, raising, or lowering

“Hole” generally refers to a hollow portion through a solid body, wall, or a surface. A hole may be any shape. For example, a hole may be, but is not limited to, circular, triangular, or rectangular. A hole may also have varying depths and may extend entirely through the solid body or surface or may extend through only one side of the solid body.

“Integrally Formed” generally refers to a component and/or multiple components that are fused into a single piece. Integrally formed components are incapable of being dismantled without destroying the integrity of the component

“Jack” generally refers to a mechanical device used to lift, hold, or move heavy loads. Common types of jacks can include hydraulic jacks, screw jacks, bottle jacks, floor jacks, and scissor jacks. By way of non-limiting examples, hydraulic jacks can include bottle jacks and floor jacks, suitable for lifting vehicles and heavy equipment. Screw jacks can include lead screw jacks and worm gear jacks, often used in industrial settings for precise lifting. Scissor jacks are commonly found in vehicle toolkits for emergency tire changes. A jack can have various sources of power. For instance, it can be manually operated, electrically powered, or powered by compressed air. The operation of a jack can be manually controlled or powered by a motor to provide ease of use and increased lifting capacity.

“Lateral” generally refers to being situated on, directed toward, or coming from the side.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Longitudinal” generally refers to the length or lengthwise dimension of an object, rather than across.

“Notch” generally refers to an indentation, cut, groove, channel, and/or incision on an edge or surface. In some non-limiting examples, the notch includes a V-shaped or U-shaped indentation carved, scratched, etched, stamped, and/or otherwise formed in the edge or surface. The notch can have a uniform shape or a non-uniform shape.

“Opening” generally refers to a space or hole that something can pass through.

“Or” generally refers to a conjunction that is indicative of two or more alternatives. In other words, the word “or” connects words, phrases, and/or clauses that offer different possibilities. Usually, but not always, the word “or” only appears before the last alternative in a series of alternatives.

“Original Equipment Manufacturer” or “OEM” generally refers to an organization that makes finished devices from component parts bought from other organizations that are usually sold under their own brand in a consumer or commercial market.

“Pin” or “Peg” generally refers to an elongated piece of material such as wood, metal, plastic and/or other material. Typically (but not always), the pin is tapered at one or both ends, but the pin can be shaped differently in other examples. For example, the ends of the pin can be flattened, widened, and/or bent in order to retain the pin. Pins can be used for any number of purposes. For example, the pin can be used in machines to couple components together or otherwise act as an interface between components. Pins can also be used for holding things together, hanging things on, and/or marking a position. Normally, but not always, the pin is a small, usually cylindrical piece. In certain cases, the pin is a pointed and/or a tapered piece used to pin down, fasten things together, and/or designed to fit into holes. In other examples, the pin can have a polyhedral shape, such as with a rectangular or triangular cross-sectional shape, or an irregular shape.

“Saddle” in the context of a jack generally refers to the component that directly contacts and supports the object being lifted.

“Tow Coupler” or “Trailer Coupler” generally refers to a device used to secure a trailer, a towed vehicle, and/or other towed object to a towing vehicle. Typically, but not always, the trailer coupler is coupled to a hitch of the towing vehicle. For example, the trailer coupler can be configured to couple to a hitch ball. Common types of trailer couplers include (but are not limited to) straight tongue couplers, A-frame couplers, adjustable couplers, and fifth wheel-gooseneck couplers. The trailer coupler can include any number of mounting styles. By way of non-limiting examples, the mounting styles can include straight channel, foldaway, round tongue, A-frame, flat mount, adjustable tongue, lunette ring, gooseneck, trigger, thumb, wrap around yoke, and pin mounting styles or mechanisms. The trailer coupler in some instances can further include a trailer jack for lifting the trailer coupler to the proper height for coupling to the hitch.

“Tow Hitch”, “Trailer Hitch”, or “Hitch” generally refers to a device attached to a chassis of a vehicle for towing another object, such as a trailer, aircraft, wagon, and/or another vehicle, to name just a few examples. Tow hitches are commonly mounted with bolts or other fasteners to the chassis, but in other examples, the tow hitch can be integrally formed with the chassis and/or attached in other ways such as via welding. Typically, but not always, the trailer hitch is coupled to a trailer coupler that is secured to the towed object. There are a number of types of tow hitches. For example, the tow hitch can include receiver type and fixed drawbar type hitches. Receiver type hitches can include a receiver mounted to the chassis and a removable mount that is connected to the receiver. In one form, the receiver is in the form of a receiver tube that defines a receiver opening in which the removable mount is mounted, such as via a bolt or other fastener, and/or otherwise connected. The removable mount can for example include one or more ball mounts, hitch bike racks, cargo carriers, and/or other hitch mounted accessories. Fixed drawbar type hitches are typically, but not always, built as a unitary piece that is mounted to the chassis. The fixed drawbar type hitch normally includes one or more holes for a trailer ball or other mounts. The trailer mounts can for instance take the form of a tow ball to allow swiveling and articulation of a trailer; a knuckle coupling; a tow pin or a tow hook with a trailer loop coupling; and/or a pintle and lunette ring coupling. The tow hitches can for instance include Society of Automotive Engineers (SAE) class I, II, III, IV, and V hitches

“Trailer” generally refers to an unpowered vehicle towed by another vehicle. For instance, a trailer can include a nonautomotive vehicle designed to be hauled by road, such as a vehicle configured to transport cargo, to serve as a temporary (or permanent) dwelling, and/or acting as a temporary place of business. Some non-limiting examples of trailers include open carts, semi-trailers, boat trailers, and mobile homes, to name a just few. Typically, trailers lack a power train for propelling themselves over long distances and require another powered vehicle to move them. However, trailers may include a power source, such as a battery or generator, for powering auxiliary equipment

“Transverse” generally refers to things, axes, straight lines, planes, or geometric shapes extending in a non-parallel and/or crosswise manner relative to one another. For example, when in a transverse arrangement, lines can extend at right angles or perpendicular relative to one another, but the lines can extend at other non-straight angles as well such as at acute, obtuse, or reflex angles. For instance, transverse lines can also form angles greater than zero (0) degrees such that the lines are not parallel. When extending in a transverse manner, the lines or other things do not necessarily have to intersect one another, but they can.

“Unitary” generally refers to a single, continuous entity formed without multiple pieces.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, vans, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### Reference Numbers

100 system
105 vehicle
110 hitch
112 chassis
113 body
114 frame
115 hitch mount
120 hitch receiver
122 receiver tube
125 opening
130 hitch pin holes
135 fastener
140 jack point
145 recovery point
205 jack
210 saddle
215 ram
220 filler plug
225 lever
230 ground
305 receiver portion
310 engagement portion
315 receiver end
320 engagement end
325 shank
330 adjustment holes
335 step
340 cradle
345 recovery opening
405 notch
410 nose
415 jack surface
420 nose sidewall
425 receiver sidewall
430 tip
435 nose extension distance
440 notch depth
445 cavity
450 adjustment hole diameter
455 recovery opening diameter
505 vertical force vector
510 horizontal force vector
605 shaft width
610 engagement width
805 strap
905 shackle
910 crown
915 ears
920 bolt
922 nut
925 clip
1005 hitch mount
1010 engagement portion
1015 cradle
1020 catch
1025 saddle opening
1105 hitch
1110 vehicle
1120 hitch receiver
1125 opening
1130 hitch pin holes
1205 hitch mount
1210 shank
1215 engagement portion
1220 recovery opening
1225 cradle
1305 notch
1310 nose
1315 jack surface
1320 bowed surface
1325 beveled surface
1330 hook
1335 groove
1340 tip
1345 nose extension distance
1350 notch depth
1355 cavity
1405 vehicle
1410 front bumper guard
1415 jack
1420 saddle

What is claimed is:

1. A system, comprising:
a hitch mount configured to extend from a vehicle;
wherein the hitch mount has a jack point; and
wherein the jack point is configured to engage a jack.

2. The system of claim 1, wherein:
the hitch mount has a cradle;
the cradle is the jack point; and
the cradle has a jack surface configured to engage the jack.

3. The system of claim 2, wherein:
the hitch mount defines a notch configured to receive the jack; and
the notch forms the cradle.

4. The system of claim 3, wherein:
the hitch mount has a nose;
the nose is configured to keep the jack in engagement with the hitch mount during lifting; and
the nose extends from the hitch mount farther than the rest of the hitch mount.

5. The system of claim 4, wherein the hitch mount has a catch that spans across the cradle to define a cradle opening.

6. The system of claim 4, wherein:
the nose has a hook;
the hitch mount has a beveled surface and a bowed surface extending on opposing sides of the jack surface;
the cradle has a groove defined between the bowed surface and the hook; and
the hook is configured to retain the jack in engagement with the hitch mount.

7. The system of claim 6, wherein:
the bowed surface is configured to prevent the jack from sliding off the hitch mount during lifting with the jack; and
the beveled surface is shaped to facilitate insertion of the jack into the cradle.

8. The system of claim 1, wherein:
the hitch mount has a recovery point; and
the recovery point is configured to couple to a recovery accessory.

9. The system of claim 8, wherein:
the hitch mount defines a recovery opening; and
the recovery point is the recovery opening.

10. The system of claim 1, wherein the hitch mount is configured to detachably couple to a hitch receiver.

11. The system of claim 10, wherein:
the hitch mount defines one or more adjustment holes; and
the adjustment holes are configured to adjust a length of the hitch mount extending from the hitch receiver to adjust a stroke length of the jack needed to lift the vehicle.

12. The system of claim 10, wherein:
the hitch mount has a receiver portion configured to secure in the hitch receiver;
the hitch mount has an engagement portion extending from the hitch receiver;
the hitch mount has a step between the receiver portion and the engagement portion;
the engagement portion defines a recovery opening; and
the engagement portion is thinner than the receiver portion to facilitate securing of a recovery accessory to the recovery opening.

13. The system of claim 10, further comprising:
the hitch receiver; and
wherein the hitch receiver is a class 3 or higher hitch receiver type.

14. The system of claim 1, further comprising:
a front bumper guard; and
wherein the hitch mount is integrated into the front bumper guard.

15. A method, comprising:
inserting a hitch mount into a hitch receiver of a vehicle;
securing the hitch mount to the hitch receiver;
aligning a jack with a jack point on the hitch mount; and
lifting the vehicle with the jack via the hitch mount.

16. The method of claim 15, further comprising:
lowering the vehicle with the jack.

17. The method of claim 15, further comprising:
coupling a recovery accessory to a recovery point on the hitch mount; and
pulling the vehicle via the recovery accessory coupled to the recovery point of the hitch mount.

18. The method of claim 15, wherein the aligning the jack includes positioning the jack in a lateral location that is transverse to the hitch mount.

19. The method of claim 15, wherein:
the hitch mount has a cradle;
the cradle is the jack point; and
the aligning the jack with the jack point includes inserting a saddle of the jack into the cradle.

20. The method of claim 19, further comprising:
retaining the jack on the hitch mount with a nose of the hitch mount during the lifting.
